(19) United States
(12) Patent Application Publication
(10) Pub. No.: US 2019/0188324 A1
(43) Pub. Date: Jun. 20, 2019

(54) ENRICHING A KNOWLEDGE GRAPH

(71) Applicant: Microsoft Technology Licensing, LLC, Redmond, WA (US)

(72) Inventors: Bing Zhao, Sunnyvale, CA (US); Goang-Tay Hsu, San Jose, CA (US); Francis Tsang, Cupertino, CA (US)

(21) Appl. No.: 15/844,072

(22) Filed: Dec. 15, 2017

(51) Int. Cl. G06F 17/30

(52) U.S. Cl. CPC G06F 17/30867; G06F 17/30973; G06F 17/30991; G06F 17/30976

(57) ABSTRACT

Method and system for enriching a knowledge graph are described. The knowledge graph enrichment system provides a way of generating candidates for a new node ready to be folded into the existing graph, and also a new way of connecting nodes via semantic equivalence inferred via the proposed approach. The technical problem of inferring the sematic equivalent entities and relating them automatically in the knowledge graph is addressed by providing the methodology that utilizes neural machine translation via round trip translations through one or more bridging languages. A bridging language is a natural or an artificial morphologically-rich language.

### TECHNICAL FIELD

This application relates to the technical fields of software and/or hardware technology and, in one example embodiment, to system and method for enriching a knowledge graph.

### BACKGROUND

A knowledge graph is the life-blood, which is powering AI (artificial intelligence), including search (e.g., Google® search), programs designed to simulate a person as a conversation partner (chatbots), as well as many recommendation systems including feeds, news and beyond. Building a knowledge graph is often cumbersome and time consuming, for reasons such as the need for disambiguation and resolution.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system for enriching a knowledge graph may be implemented;

FIG. 2 is block diagram of a system for enriching a knowledge graph, in accordance with one example embodiment;

FIG. 3 is a flow chart of a method for enriching a knowledge graph, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system for enriching a knowledge graph in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

An on-line social network may be viewed as a platform to connect people in virtual space, where registered members establish and document networks of people. Each registered member of an on-line social network may be represented by a member profile (also referred to as a profile of a member or simply a profile), which, in turn, may be represented by one or more web pages, a structured representation of the member's information in XML (Extensible Markup Language), JSON (JavaScript Object Notation) or similar format. A member's profile web page of a social networking web site may emphasize employment history and education of the associated member. A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, provide recommendations and endorsements for each other and otherwise be in touch via the social network.

The profile information of a social network mein may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management.,” “patent prosecution,” “image processing,” etc.). The profile of a member may also include information about the member's current and past employment, such as company identifications, professional titles held by the associated member at the respective companies, as well as the member's dates of employment at those companies.

As mentioned above, the on-line social network that permits users to search for specific type of information, such as, e.g., job postings, people engaged in a particular professional endeavour, etc. The search system provided with the on-line social network utilizes a knowledge graph that stores data items (also referred to as entities) and relationships between data items, permits processing of queries provided in a style of a natural language, as well as allows derivation of implicit information from explicit data. The nodes in the knowledge graph represent entities of various entity types available in the online social network system. Example entity types are skill, title, company, school, industry, etc. Thus, “software engineer” is an entity of entity type “title” and it can be represented by a node in the knowledge graph. The nodes representing entities “software engineer” and “software developer” can be connected in the graph by an edge to signify that these two entities may be treated as equivalent or synonymous for purposes such as, e.g., member search or job search.

In the era of international users, a challenge to address in the use of knowledge graphs is the ability to handle world knowledge well. For instance, a nurse is called “sister” in Germany and India, while in the English-speaking, realm these two terms would not be perceived as related, even less so as synonymous. Given that the space of the surface forms for any given entity can be vastly unlimited due to the ambiguities of language, a knowledge graph enrichment system is proposed for inferring the sematic equivalent entities and relating them automatically in the knowledge graph via round trip translations through bridging languages. Such bridging language can be a machine language or a morphology rich human language (such as, e.g., German or Finnish). For instance, given the title term “CEO,” the knowledge graph enrichment system a can generate equivalent entities, such as “President and CEO” and “Board of Directors Chairman” in the title domain of the online social network system. Another example is the entity “nurse,” which can be correctly related to the entity “Sister” in the domain knowledge of health industry in the online social network system, using the knowledge graph enrichment system. The knowledge graph enrichment system provides a way of generating candidates for new node ready to be fold into the knowledge graph, and also a new way of connecting nodes via semantic equivalence inferred via the proposed approach; thus, the knowledge graph can be enriched in terms of new node and also edges.

Beyond the creating of new nodes and edges in the knowledge graph, the knowledge graph enrichment methodology has a few immediate use cases, such as query-expansion, where a query submitted by a user can be rewritten into a different form which may be easier for search. For instance the query string “what is the price of tesla” can be rewritten as “what is the cost of tesla” or “how much does tesla cost.” Yet another example is for expanding the ambiguities for any given key word in the search. For instance the keyword “sentence” can be disambiguated into the synonyms, such as “verdict” or “judgment” by examining the node in the knowledge graph representing the entity “sentence” and the nodes connected to the “sentence” node by edges indicating equivalence.

The technical problem of inferring the sematic equivalent entities and relating them automatically in the knowledge graph is addressed by providing the methodology that utilizes neural machine translation via round trip translations through bridging languages, as described in further detail below.

In one embodiment two neural machine translation (NMT) engines are built. The first one, the source-to-target NMT engine, is configured to translate phrases from the source language (e.g., from English) to a so-called bridging language to obtain a list of potential synonyms in the bridge language. The other one, the target-to-source NMT engine, is configured to translate phrases, including the list of potential synonyms from the bridging language, back to the source language. As mentioned above, the language selected to serve as a bridging language is a morphology rich language, such as, e.g., German or Finnish or even an artificial language. In some embodiments, a bridging language has different word surface forms for different semantic meanings, such as, “verdict” and “sentence.”

The training data for the NMT engines is selected such that the source and target data context are semantically aligned, and not as strict as the word-to-word aligned as in traditional statistical machine translation. Thus trained NMT engine can infer the semantically loosely aligned words and their meanings in the attention layer in the NMT engine. This allows the use of many comparable data sources, such as existing collaborative knowledge bases and multilingual data mined in the on-line social network system, especially in the domains for job postings, member profiles and query logs. Another source of comparable data includes query logs. When users are not satisfied with the first query-retrievals, they tend to enrich the query with more details (e.g., by including additional phrases) or rewrite the query more accurately (e.g.., by clarifying ambiguities) or rephrase the query based on their knowledge. For example, the query “software engineer at Google” may be rephrased as “software developer at Google.” As the on-line social network system hosts a vast amount of data related to jobs, titles, skills, and companies, this data can be leveraged in training the NMT engines.

In some embodiments, an NMT engine can be initialized with word embeddings. In the domain of the on-line social network system, structured data, such as entities of entity type skills, titles and company names, is available in the member profiles. This data can be used as supervised labels. Word embeddings can be learned from the text in the domain and tagged with respective tags. For example, a raw sentence in a member profile summary reading “I am a software engineer and I am a code ninja in Java” can be automatically tagged as “I am a <title> software engineer </title> and I am a <title> code ninja </title> in <skill> java </skill>.” These tags indicate that “code ninja” and “software engineer” are both entities of the “title” entity type and “Java” is an entity of the “skill” entity type. Such labeled data can be used for domain-specific synonym modeling and can also enable a supervised (or semi-supervised as only partially labeled) data to learn in-domain word-embeddings to empower the NMT engines to be more insightful to the domain-specific synonyms (e.g., to recognize that “code ninja” is in some way a synonym for “software engineer”).

N-best decoding is enabled for both NMT engines, such that the translation engine produces, for a source phrase, a list of multiple translated phrases that are potentially equivalent or synonymous, rather than providing the single most likely translation. This list of translated phrases is referred to as an n-best list. N-best decoding contributes beneficially to generating enough varieties of translated phrases to be ranked later for greater accuracy. Additionally, in some embodiments, the synonyms in the n-best list are ranked using language model scores of ‘Full-Match’ for the keywords that have been previously used by members of the on-line social network system and are stored in the query log maintained by the on-line social network system. The n-best list can also be further ranked using ‘Partial-Match’ language model scores, as well as other meta scores.

In operation, a knowledge graph enrichment system accesses a phrase represented by a node in the knowledge graph (referred to a as a subject phrase to indicate that it is the subject of the operations performed by the knowledge graph enrichment system) and provides it as input to the source-to-target NMT engine. The source-to-target NMT engine generates an n-best list of phrases in the bridging language that are translations of the subject phrase into the bridging language. The phrases in the bridging language from the n-best list are provided, as input to the target-to-source NMT engine, which, in turn, produces an n-best list of phrases in the source language. The entries in this list, produced by the target-to-source NMT engine (and that includes, most likely, the subject phrase, but also includes, in many cases, additional phrases), can be ranked based on the frequency of occurrence of the respective list items in member profiles as entities of the same type as the entity type associated with the subject phrase. Using one of the examples discussed above, starting with the subject phrase “nurse,” which may be an entity of entity type “title” and may be represented by a node in the knowledge graph, the round-trip process of engaging source-to-target NMT engine and the target-to-source NMT engine reveals that the phrase “nurse” can be treated as synonymous to the phrase “sister,” at least in the context of the medical field. Subsequent to determining that the phrase “sister” has a sufficiently high rank, using the approached described above, the knowledge graph is enhanced by adding to it a node representing the entity “sister” and also an edge connecting it to the node representing the entity “nurse.”

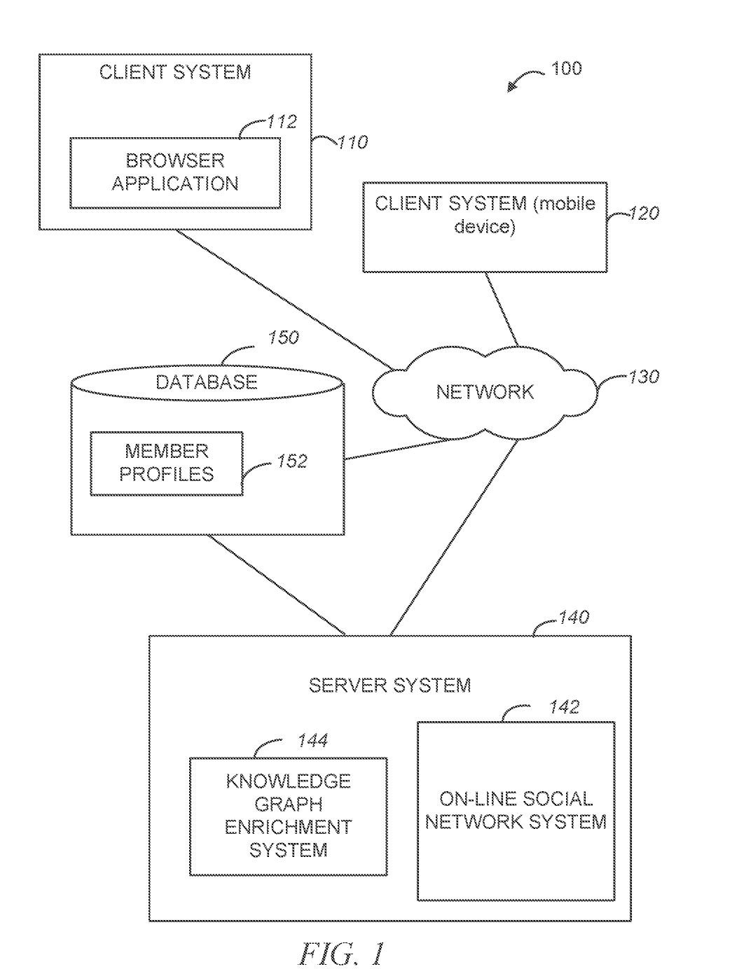

In some embodiments, the NMT engines described herein can be used to evaluate the distance between two given nodes that represent respective entities in a knowledge graph, and, based on the resulting confidence score, determine whether a new edge is to be created in the graph or whether an existing edge is to be deleted. Example system for enriching a knowledge graph in an on-line social network system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

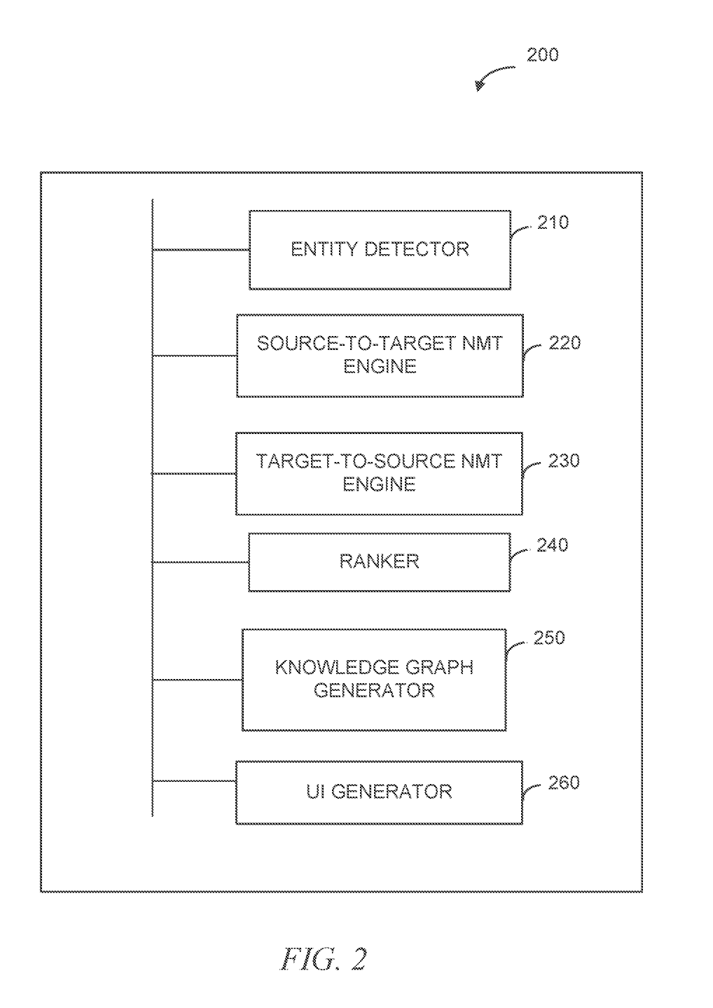

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a knowledge graph enrichment system 144 for enriching a knowledge graph using the methodologies described herein. The knowledge graph enrichment system 144 may be part of or in communication with the on-line social network system 142. An example knowledge graph enrichment system 144 is illustrated in FIG. 2.

FIG. 2 is a block diagram of a system 200 for enriching a knowledge graph, in accordance with one example embodiment. The system 200, in some embodiments, corresponds to the knowledge graph enrichment system 144. As shown in FIG. 2, the system 200 includes an entity detector 210, a source-to-target NMT engine 220 and a target-to-source NMT engine 230, a ranker 240, a knowledge graph generator 250, and a UI generator 260.

The entity detector 210 is configured to access a focus entity represented by a focus node in a knowledge graph in the on-line social network system 142. The focus entity is a phrase (comprising one or more words) in a source language (e.g., in English). As discussed above, an entity is an instance of an entity type. For example “software engineer” is an entity of entity type “title” and it can he represented by a node in the knowledge graph.

The source-to-target NMT engine 220 is configured to take the focus entity, or any phrase in the source language, as input and to produce a set of phrases translated into a bridging language (a set of translated phrases). For example, as already mentioned above, when the entity “nurse.” which may be an entity of entity type “title” and may be represented by a node in the knowledge graph, is provided as input to the source-to-target NMT engine 220, the source-to-target NMT engine 220 produces the list of translated phrases that includes phrases in the bridging language that correspond to the English language “nurse” and also “sister.” Also as explained above, the bridging language can be a machine language or a morphology rich human language (such as, e.g., German or Finnish). The target-to-source NMT engine 230 is configured to take as input the set of translated phrases and to produce a list of phrases in the source language. The ranker 240 is configured to rank the phrases in the resulting list of phrases in the source language using information obtained from the online social network system. Such information obtained from the online social network system can be, e.g., the frequency of occurrence of respective items from the list of phrases in the source language in the member profiles maintained in the on-line social network system 142 the frequency of occurrence of respective items from the list of phrases in the source language in the query log maintained in the on-line social network system 1142. The knowledge graph generator 250 is configured to select, based on the ranking, a phrase from the list of phrases in the source language and create a new node and a new edge in the knowledge graph. The new node represents the new entity corresponding to the selected phrase and the new edge, the edge between the focus node and the new node, represents synonymy or equivalence between the respective entities represented by the respective nodes.

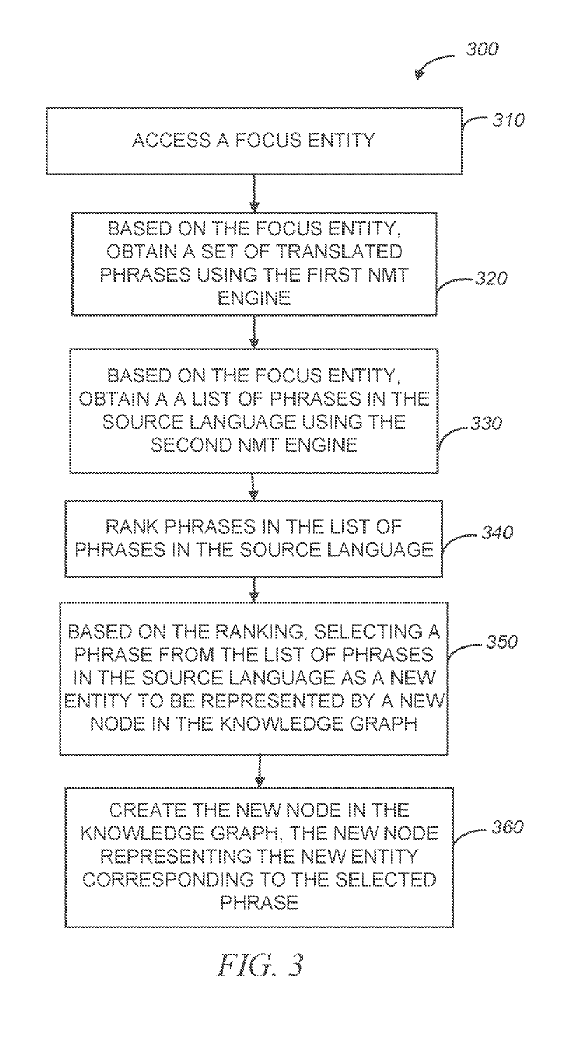

The system 200 is also configured to detect a string in a search box provided in a search user interface (UI) in the on-line social network system 142, determine that the string includes a phrase corresponding to an entity represented by a node in the knowledge graph, determine an equivalent or synonymous entity based on an edge connecting the node representing the entity and another node, include a reference to the equivalent or synonymous entity into the search UI, and cause presentation, on a display device, the search UI with the included reference to the selected phrase. The including of the reference to the selected phrase into the search UI comprises presenting the selected phrase in the search box as a type-ahead string or presenting the selected phrase in a list of suggested search terms for selection by a user. The system can then retrieve search results based on the selected phrase, in addition to retrieving search results based on the focus entity. Some operations performed by the system 200 may be described with reference to FIG. 3.

FIG. 3 is a flow chart of a method 300 for enriching a knowledge graph, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the entity detector 210 of FIG. 2 accesses a focus entity represented by a focus node in a knowledge graph in the on-line social network system 142. The source-to-target NMT engine 220 of FIG. 2 takes the focus entity as input and produces a set of phrases translated into a bridging language (a set of translated phrases), at operation 320. At operation 330, the target-to-source NMT engine 230 of FIG. 2 takes as input the set of translated phrases and produces a list of phrases in the source language. The ranker 240 of FIG. 2 ranks the phrases in the resulting list of phrases in the source language using information obtained from the online social network system, at operation 340. The knowledge graph generator 230 selects, at operation 350, based on the ranking, a phrase from the list of phrases in the source language and, at operation 360, creates a new node and a new edge in the knowledge graph. The new node represents the new entity corresponding to the selected phrase and the new edge, the edge between the focus node and the new node, represents synonymy or equivalence between the respective entities represented by the respective nodes.

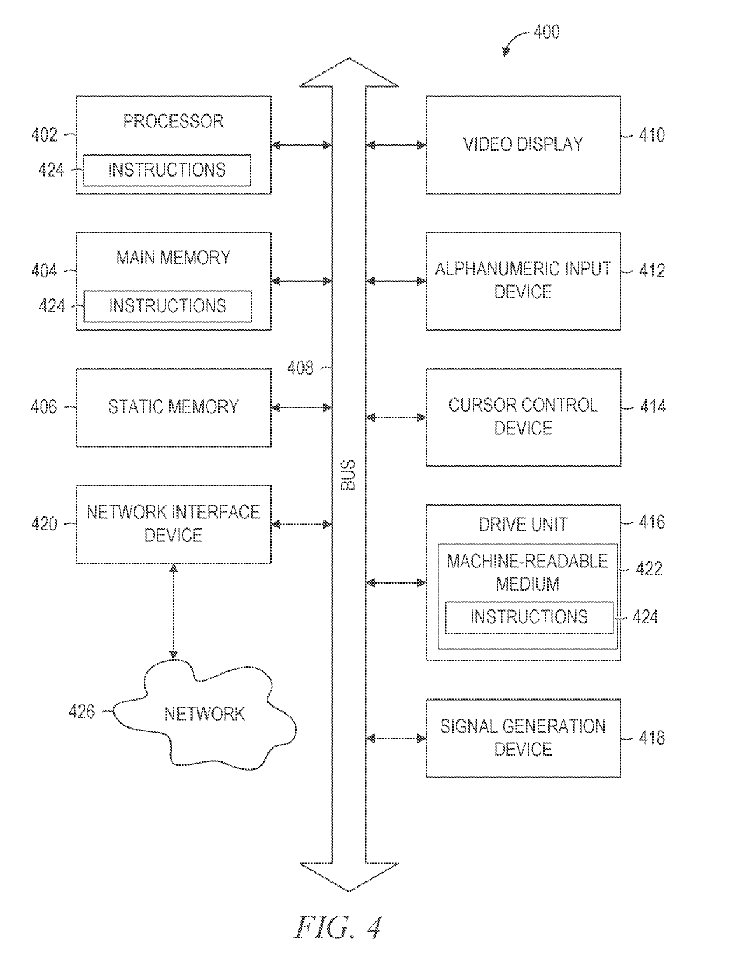

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken b that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable; medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMS), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to an single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or More computer systems (e.g., a standalone, client of server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications ma be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system for enriching a knowledge graph have been described. Although embodiments have been described with reference to specific example embodiments, it will be evident that various modifications and changes may be made to these embodiments without departing from the broader scope of the inventive subject matter. For example, while method and system for enriching a knowledge graph have been described in the context of an on-line social network, the methodologies described herein may be used beneficially any environment that utilizes a knowledge graph. Accordingly, the specification and drawings are to be regarded in an illustrative rather than a restrictive sense.

1. A computer-implemented method comprising:
accessing a focus entity represented by a focus node in a knowledge graph in an on-line social network system, the focus entity is a phrase in a source language;
providing the focus entity as input to a first neural machine translation (NMT) engine to obtain a set of translated phrases, the first NMT engine to translate phrases from the source language to a bridging language;
providing the set of translated phrases as input to a second NMT engine to obtain a list of phrases in the source language;
ranking phrases in the list of phrases in the source language using information obtained from the online social network system;
based on the ranking, selecting a phrase from the list of phrases in the source language as a new entity to be represented by a new node in the knowledge graph; and
using at least one processor coupled to a memory, creating the new node in the knowledge graph, the new node representing the new entity corresponding to the selected phrase, and a new edge between the focus node and the new node.

2. The method of claim 1, wherein the new edge indicates that the focus phrase and the selected phrase are equivalent or synonymous.

3. The method of claim 1, comprising:
detecting a string in a search box provided in a search user interface (UI) in the on-line social network system;
determining that the string includes a phrase corresponding to the focus entity;
based on the focus entity and using the knowledge graph, determining the selected phrase corresponding to the new entity represented by the new node in the knowledge graph;
including a reference to the selected phrase into the search and
causing presentation, on a display device, the search UI with the included reference to the selected phrase.

4. The method of claim 3, wherein the including of the reference to the selected phrase into the search UI comprises presenting the selected phrase in the search box as a type-ahead string.

5. The method of claim 3, wherein the including of the reference to the selected phrase into the search UI comprises presenting the selected phrase in a list of suggested search terms for selection by a user.

6. The method of claim 3, comprising retrieving search results based on the selected phrase in addition to retrieving search results based on the focus entity.

7. The method of claim 1, wherein the ranking of phrases in the list of phrases in the source language is based on frequency of occurrence of respective items from the list of phrases in the source language in the member profiles maintained in the on-line social network system.

8. The method of claim 1, wherein the ranking of phrases in the list of phrases in the source language is based on frequency of occurrence of respective items from the list of phrases in the source language in a query log, the query log including information about searches processed in the on-line social network system.

9. The method of claim 1, wherein the bridging language is an artificial language.

10. The method of claim 1, wherein the bridging language is a morphologically rich language.

11. A system comprising:
one or more processors; and
a non-transitory computer readable storage medium comprising instructions that when executed by the one or processors cause the one or more processors to perform operations comprising:
accessing a focus entity represented by a focus node in a knowledge graph in an on-line social network system, the focus entity is a phrase in a source language;
providing the focus entity as input to a first neural machine translation (NMT) engine to obtain a set of translated phrases, the first NMT engine to translate phrases from the source language to a bridging language;
providing the set of translated phrases as input to a second NMT engine to obtain a list of phrases in the source language;
ranking phrases in the list of phrases in the source language using information obtained from the online social network system;
based on the ranking, selecting a phrase from the list of phrases in the source language as a new entity to be represented by a new node in the knowledge graph; and
creating the new node in the knowledge graph, the new node representing the new entity corresponding to the selected phrase, and a new edge between the focus node and the new node.

12. The system of claim 11, wherein the new edge indicates that the focus phrase and the selected phrase are equivalent or synonymous.

13. The system of claim 11, comprising:
detecting a string in a search box provided in a search user interface (UI) in the on-line social network system;
determining that the string includes a phrase corresponding to the focus entity;
based on the focus entity and using the knowledge graph, determining the selected phrase corresponding to the new entity represented by the new node in the knowledge graph;
including a reference to the selected phrase into the search UI and
causing presentation, on a display device, the search UI with the included reference to the selected phrase.

14. The system of claim 13, wherein the including of the reference to the selected phrase into the search UI comprises presenting the selected phrase in the search box as a type-ahead string.

15. The system of claim 13, wherein the including of the reference to the selected phrase into the search UI comprises presenting the selected phrase in a list of suggested search terms for selection by a user.

16. The system of claim 13, comprising retrieving search results based on the selected phrase in addition to retrieving search results based on the focus entity.

17. The system of claim 11, wherein the ranking of phrases in the list of phrases in the source language is based on frequency of occurrence of respective items from the list of phrases in the source language in the member profiles maintained in the on-fine social network system.

18. The system of claim 11, wherein the ranking of phrases in the list of phrases in the source language is based on frequency of occurrence of respective items from the list of phrases in the source language in a query log, the query log including information about searches processed in the on-line social network system.

19. The system of claim 11, wherein the bridging language is an artificial language or a morphologically rich language.

20. A machine-readable non-transitory storage medium having instruction data executable by a machine to cause the machine to perform operations comprising:
accessing a focus entity represented by a focus node in a knowledge graph in an on-line social network system, the focus entity is a phrase in a source language;
providing the focus entity as input to a first neural machine translation (NMT) engine to obtain a set of translated phrases, the first NMT engine to translate phrases from the source language to a bridging language;
providing the set of translated phrases as input to a second NMT engine to obtain a list of phrases in the source language;
ranking phrases in the list of phrases in the source language using information obtained from the online social network system;
based on the ranking, selecting a phrase from the list of phrases in the source language as a new entity to be represented by a new node in the knowledge graph; and
creating the new node in the knowledge graph, the new node representing the new entity corresponding to the selected phrase, and a new edge between the focus node and the new node.
